(19) United States
(12) Patent Application Publication
(10) Pub. No.: US 2022/0194806 A1
(43) Pub. Date: Jun. 23, 2022

(54) LITHIUM OXIDE RECOVERY METHOD FROM LITHIUM MANGANESE OXIDE (LMO)

(71) Applicant: PUKYONG NATIONAL UNIVERSITY INDUSTRY-UNIVERSITY COOPERATION FOUNDATION, Busan (KR)

(72) Inventor: Jei Pil WANG, Busan (KR)

(73) Assignee: PUKYONG NATIONAL UNIVERSITY INDUSTRY-UNIVERSITY COOPERATION FOUNDATION, Busan (KR)

(21) Appl. No.: 17/456,109

(22) Filed: Nov. 22, 2021

(30) Foreign Application Priority Data
Dec. 22, 2020 (KR) 10-2020-0180594

(51) Int. Cl. C01D 15/02

(52) U.S. Cl. CPC C01D 15/02

(57) ABSTRACT

A method for recovering lithium oxide from lithium manganese oxide (LMO) includes producing lithium oxide (Li₂O) via thermal reaction of lithium manganese oxide (LMO) in an hydrogen atmosphere, and performing water leaching of the produced lithium oxide to separate the lithium oxide from other products.

### CROSS-REFERENCE TO RELATED APPLICATION

This application claims a benefit under 35 U.S.C. § 119(a) of Korean Patent Application No. 10-2020-0180594 filed on Dec. 22, 2020, with the Korean Intellectual Property Office, the entirety of the disclosure of which is incorporated herein by reference for all purposes.

### BACKGROUND

### Field

The present disclosure relates to a method for recovering lithium oxide via reduction of lithium manganese oxide (LMO) using hydrogen.

### Description of Related Art

Types of positive electrode active materials for lithium ion batteries include LiCoO₂, LiMnO₂, LiFePO₄, and the like. Conventionally, LiCoO₂ has been mainly used. However, as cobalt has rarity and price volatility thereof increases and high safety of the battery is required, various positive electrode materials such as Li(NCM)O₂, LiMn₂O₄, and LFP have been developed. LiMn₂O₄ has a spinel structure and thus is structurally stable, is advantageous for high-efficiency charge/discharge. Further, LiMn₂O₄ is widely used because of advantages of Mn such as price competitiveness and stability at high temperatures. In particular, as the battery capacity increases, safety becomes more important. In this connection, manganese spinel is more stable than an existing layered structure. As of 2015, the global demand for LiMn₂O₄ is 23,941 tons. Further, the demand therefor is expected to increase further due to the high growth of the annual production rate thereof. Accordingly, importance of developing recycling schemes for end-of-life lithium manganese oxide (LMO) is growing.

Lithium is an element belonging to alkali metals and has a low reduction potential, and thus may be used as a positive electrode for lithium primary and secondary batteries, and is used throughout industries as reducing agents, alloy additives, and nuclear fusion raw materials. Lithium is the most widely used in the lithium battery, and is a rare metal that is entirely dependent on imports. Most lithium raw materials produced in Korea are produced using an extraction process from seawater. Research on recovering and producing into lithium carbonate, lithium phosphate, and lithium hydroxide from waste batteries and lithium ore is ongoing.

A method for recycling lithium from a discarded lithium ion battery includes a method of treating and leaching a waste lithium ion battery with a chemical and then separating lithium therefrom or recovering lithium oxide and then inputting the recovered lithium oxide into the lithium ion battery into a lithium ion battery manufacturing process. Compared to other processes, this method has the advantage of high reaction rate and yield, and easy control of powder particle size and shape. However, there are disadvantages in that a strong acid solution and chemicals harmful to the environment are used, the production process is complicated due to the generation of a large amount of intermediate products, and the production cost is raised up as the amount of waste solution is increased.

In addition to recycling waste lithium-ion batteries, lithium is also recovered by evaporating water from brine and adding sodium carbonate thereto to obtain lithium carbonate. In this connection, the brine is concentrated until the lithium content exceeds 0.5%, and lithium carbonate, which is not easily soluble in water, is separated. Since this method uses almost infinite seawater, there is no problem of resource depletion. However, it takes a lot of time to evaporate the water and add the sodium carbonate, and recover lithium. The lithium concentration in seawater is low (about 0.17 mg/L) such that bulk treatment equipment is essential.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide a method for recycling a waste lithium ion battery and recovering lithium oxide via heat-treating of lithium manganese oxide (LMO) in a hydrogen reducing atmosphere.

Purposes in accordance with the present disclosure are not limited to the above-mentioned purpose. Other purposes and advantages in accordance with the present disclosure as not mentioned above may be understood from following descriptions and more clearly understood from embodiments in accordance with the present disclosure. Further, it will be readily appreciated that the purposes and advantages in accordance with the present disclosure may be realized by features and combinations thereof as disclosed in the claims.

One aspect of the present disclosure provides a method for recovering lithium oxide from lithium manganese oxide (LMO), the method including producing lithium oxide (Li₂O) via thermal reaction of lithium manganese oxide (LMO) in an atmospheric atmosphere, and performing water leaching of the produced lithium oxide to separate the lithium oxide from other products.

The lithium manganese oxide (LMO) is a material widely used as a positive electrode active material of a lithium ion battery, and includes lithium (Li), manganese (Mn), and the like.

When the lithium manganese oxide (LMO) is subjected to a thermal reaction in an atmospheric atmosphere, components of the lithium manganese oxide (LMO) are decomposed by heat, and lithium oxide is produced. In addition to the lithium oxide, manganese oxide, manganese dioxide, etc. may be produced. In this connection, the atmospheric atmosphere may be controlled by hydrogen gas, and may be a hydrogen based reduction atmosphere in which the lithium manganese oxide (LMO) is reduced by the hydrogen gas. The thermal reaction may allow the lithium oxide to be produced without treatment with a strong acid solution or chemicals that have been conventionally used to produce lithium oxide.

The thermal reaction may be performed at about 800° C. More preferably, the thermal reaction may be performed at about 1000° C. The temperature range refers to a temperature at which the lithium manganese oxide (LMO) undergoes a phase change.

The water leaching is performed to separate the prepared lithium oxide from other materials. The water leaching is performed by mixing distilled water and other samples in a certain mixing ratio. This is used in that the solubility of the lithium oxide is different from that of each of manganese oxide and manganese dioxide. The lithium oxide may be obtained by washing and drying the precipitated lithium oxide. Using the water leaching, not only the lithium oxide but also other products such as manganese oxide and manganese dioxide may be obtained.

According to the present disclosure, lithium oxide may be obtained via a simple method of heat-treating the waste lithium ion battery. In addition, the above method may recycle the waste lithium ion battery in an environmentally friendly manner without using a strong acid solution or a chemical.

In addition to the effects as described above, specific effects in accordance with the present disclosure will be described together with following detailed descriptions for carrying out the disclosure.

### BRIEF DESCRIPTION OF DRAWINGS

FIG. 1 shows a water leaching process of a mixture obtained after thermal reaction of lithium manganese oxide (LMO).

FIG. 2 shows a TGA test result to identify a temperature at which a phase change of lithium manganese oxide (LMO) occurs.

FIG. 3 is a graph of XRD analysis of lithium manganese oxide (LMO).

FIG. 4 is a graph of XRD analysis of Present Example 1.

FIG. 5 is a graph of XRD analysis of Present Example 2.

FIG. 6 is a graph of XRD analysis of Present Example 3.

FIG. 7 is a graph of XRD analysis of Present Example 4.

FIG. 8 is a graph of XRD analysis of Comparative Example 1.

FIG. 9 is a graph of XRD analysis of Comparative Example 2.

FIG. 10 is a graph of XRD analysis of Comparative Example 3.

FIG. 11 is a graph of XRD analysis of a powder sample obtained by an example water leaching.

FIG. 12 is an SEM image of a powder sample obtained by an example water leaching.

Present Example. A method of recovering lithium oxide by thermal reaction of lithium manganese oxide (LMO) in the present disclosure in a hydrogen reducing atmosphere was performed as follows.

### DETAILED DESCRIPTION

Examples of various embodiments are illustrated and described further below. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entirety of list of elements and may not modify the individual elements of the list. When referring to “C to D”, this means C inclusive to D inclusive unless otherwise specified.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

One aspect of the present disclosure provides a method for recovering lithium oxide from lithium manganese oxide (LMO). The method includes producing lithium oxide (Li₂O) via thermal reaction of lithium manganese oxide (LMO) in a hydrogen reduction atmosphere, and recovering the produced lithium oxide (Li₂O) via water leaching. The method may be conducted by way example as follows:

### Present Example

### Present Example 1—Hydrogen Reduction Atmosphere and 350° C. Thermal Reaction

300 g of lithium manganese oxide (LMO) positive electrode active material was thermally reacted for 3 hours at 350° C. under a hydrogen reducing atmosphere (5.4 L/3 hours). In this connection, a rate of hydrogen input was 300 mL/min.

### Present Example 2—Hydrogen Reduction Atmosphere, 850° C. Thermal Reaction

The process was carried out in the same manner as in Present Example 1, except that the thermal reaction temperature was set to 850° C.

### Present Example 3—Hydrogen Reduction Atmosphere, 950° C. Thermal Reaction

The process was carried out in the same manner as in Present Example 1, except that the thermal reaction temperature was set to 950° C.

### Present Example 4—Hydrogen Reduction Atmosphere, 1150° C. Thermal Reaction

The process was carried out in the same manner as in Present Example 1, except that the thermal reaction temperature was set to 1150° C.

### Comparative Example 1—Carbon Dioxide Atmosphere, 900° C. Thermal Reaction

300 g of lithium manganese oxide (LMO) positive electrode active material was thermally reacted for 1 hour at 900° C. under a carbon dioxide atmosphere (1.8 L/hour). In this connection, a rate of carbon dioxide input was 300 ml/min.

### Comparative Example 2—Carbon Dioxide Atmosphere, 1000° C. Thermal Reaction

The process was carried out in the same manner as in Comparative Example 1, except that the thermal reaction temperature was set to 1000 ° C.

### Comparative Example 3—Carbon Dioxide Atmosphere, 1200° C. Thermal Reaction

The process was carried out in the same manner as in Comparative Example 1, except that the thermal reaction temperature was set to 1200° C.

### Example Water Leaching

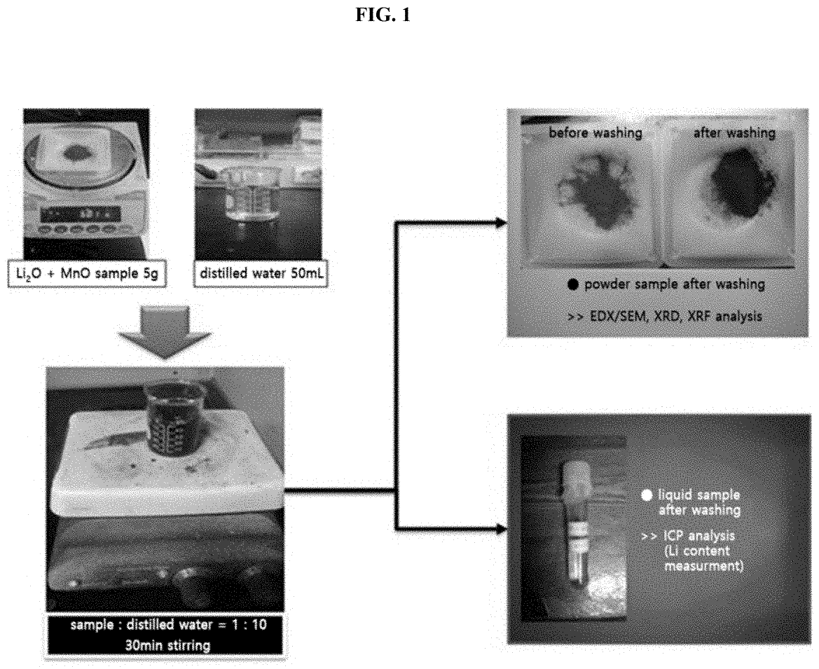

5 g of the reaction product prepared in Present Example 4 was stirred with 50 ml of distilled water at a weight ratio of 1:10 for 30 minutes for washing, and thus a water leaching process was performed to separate the powder sample and the liquid sample from each other. The water leaching process is shown in FIG. 1.

### Experimental Example

### Test 1—TGA (Thermogravimetric Analysis)

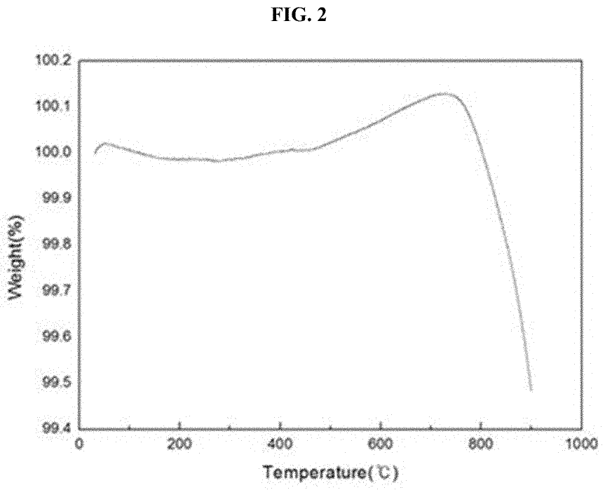

FIG. 2 identifies the temperature at which phase change occurs based on the result of testing lithium manganese oxide (LMO) with a TGA (thermogravimetric analysis) device. It may be identified that the phase change of lithium manganese oxide (LMO) occurs in the thermal reaction temperature range of the present disclosure.

### Test 2—XRD Analysis

XRD analysis of the lithium manganese oxide (LMO) and the Present Examples 1 to 4 were carried out to analyze the components of the material obtained in each of Present Examples.

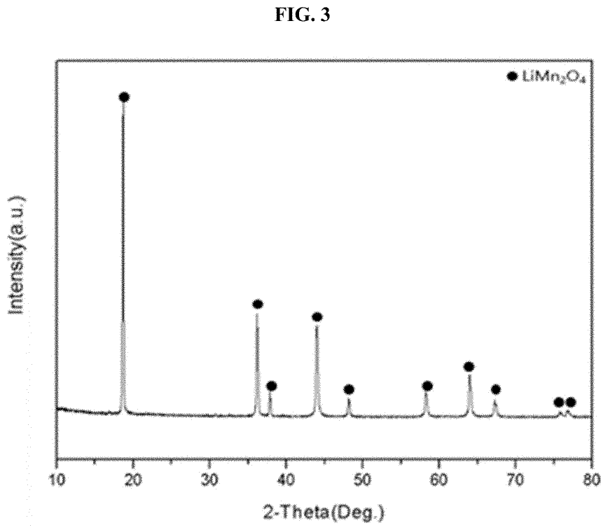

FIG. 3 is a graph of XRD analysis of lithium manganese oxide (LMO). The graph shows only the LiMn₂O₄ peak.

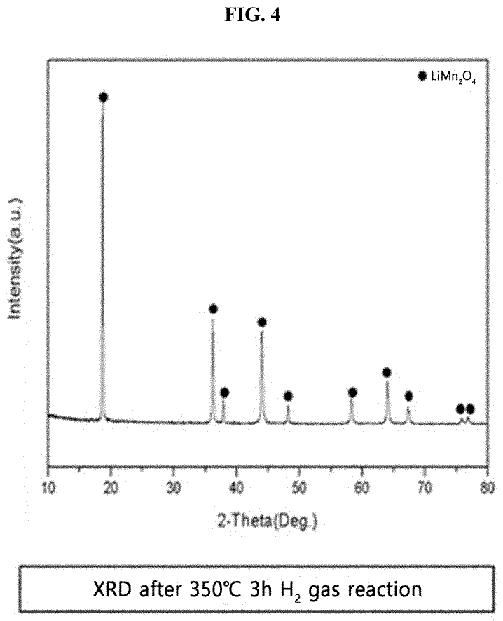

FIG. 4 is a graph of XRD analysis of Present Example 1. The graph shows the same peak as that in the XRD graph of lithium manganese oxide (LMO). This means that the phase change of LiMn₂O₄ does not occur at 350° C.

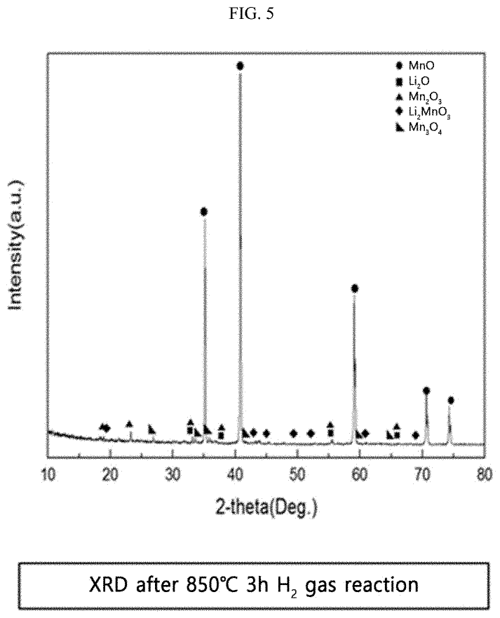

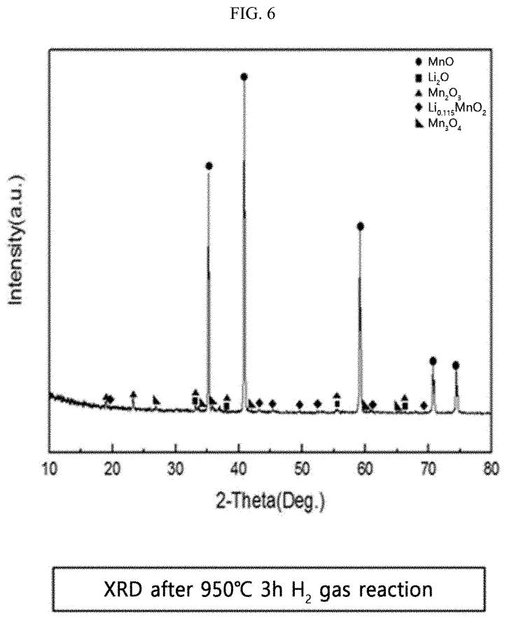

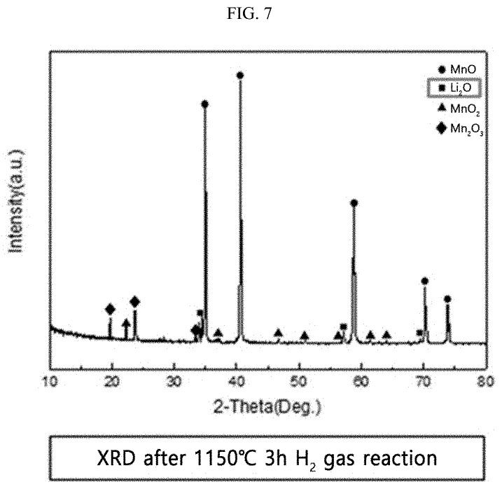

FIG. 5 is a graph of XRD analysis of Present Example 2, FIG. 6 is a graph of XRD analysis of Present Example 3, and FIG. 7 is a graph of XRD analysis of Present Example 4. All of the graphs show peaks different from that in the XRD graph of lithium manganese oxide (LMO). Unlike FIG. 3 and FIG. 4 which show only the peak of the lithium-manganese mixture, FIG. 5 to FIG. 7 show that lithium and manganese are separated from each other and separate peaks thereof are observed. This means that the phase change of lithium manganese oxide (LMO) occurs in a manner starting from a temperature of FIG. 5, that is, from 850° C. in Present Example 2.

In the graphs of FIG. 5 and FIG. 6, the peak of the starting material LiMn₂O₄ does not appear, but a large amount of MnO peak, a small amount of Li₂O peak, and a very small amount of Li₂MnO₃ or Li_{0.115}MnO₂ peak appear.

Further, in the graph of FIG. 7, the peak of LiMn₂O₄ does not appear, and a large amount of MnO peak and a small amount of Li₂O peak appear, and a peak of the compound in which Li and Mn are combined with each other is not observed. This means that the phase change of lithium manganese oxide (LMO) has been completed in the temperature of FIG. 7, that is, at 1150° C. in Present Example 4.

Therefore, it may be identified based on the results of the XRD tests of lithium manganese oxide (LMO) and Present Examples 1 to 4 that the lithium manganese oxide (LMO) undergoes a phase change via a thermal reaction at 800° C. or higher, and a substantial portion of Li and Mn are separated from each other via a thermal reaction at 1000° C. or higher.

Further, Comparative Examples 1 to 3 using carbon dioxide instead of hydrogen were subjected to XRD analysis to analyze components of the materials obtained in each of Comparative Examples.

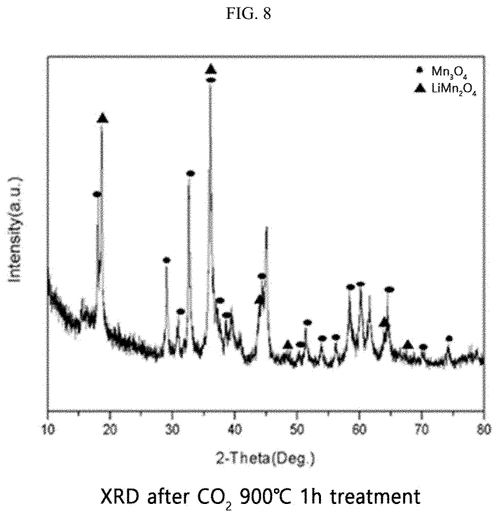

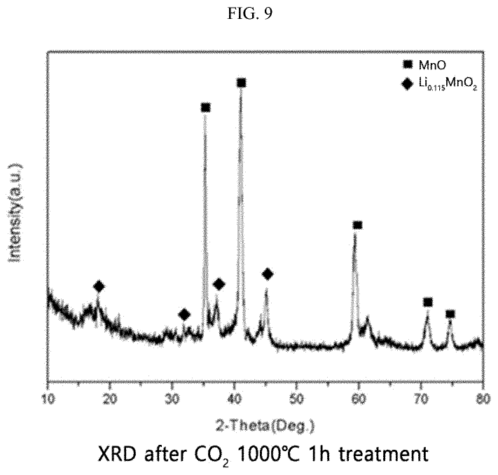

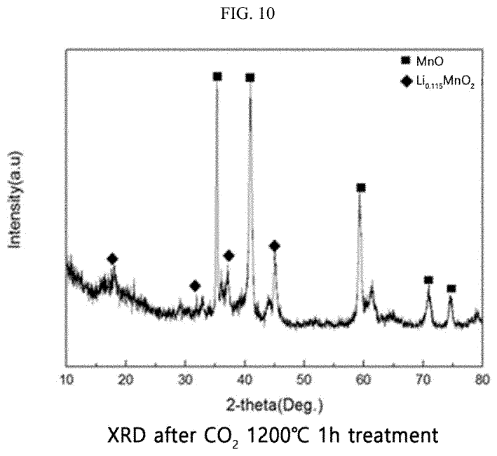

FIG. 8 to FIG. 10 are graphs of XRD analysis of Comparative Examples 1 to 3, respectively. In all of the above graphs, a phase change of LiMn₂O₄ occurs via a thermal reaction. Thus, the graphs show peaks different from that in the XRD graph of lithium manganese oxide (LMO). However, in Comparative Example 1, a peak of LiMn₂O₄ is observed, and in Comparative Examples 2 and 3, a peak of Li_{0.115}MnO₂ is observed.

Therefore, it may be identified based on the results of the XRD tests of lithium manganese oxide (LMO) and Comparative Examples 1 to 3 that when carbon dioxide is used instead of hydrogen, the thermal reaction proceeds at a temperature significantly higher than the thermal reaction temperature range of the Present Examples, resulting in a phase change of only a portion thereof, such that the complete separation between Li and Mn is not achieved.

### Test 3—ICP-OES Analysis of Liquid

The liquid sample obtained through the example water leaching was analyzed using ICP-OES to measure the lithium content in the liquid sample.

It may be identified based on the result of the ICP-OES analysis, a Li element is present in the liquid sample and the Li element is contained at a content of 1928.21 ppm, so that Li is separated from Mn via the process according to the present disclosure.

### Test 4—XRD Analysis and SEM Images of Powders

The powder sample obtained through the example water leaching was subjected to XRD analysis and was subjected to SEM imaging to observe the powder particles and shape thereof in the powder sample.

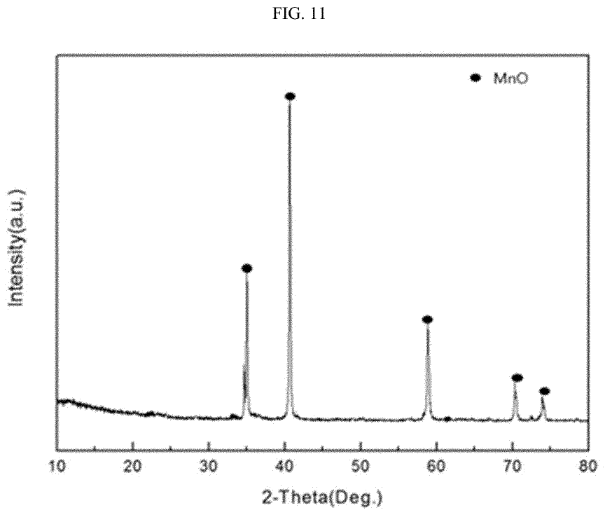

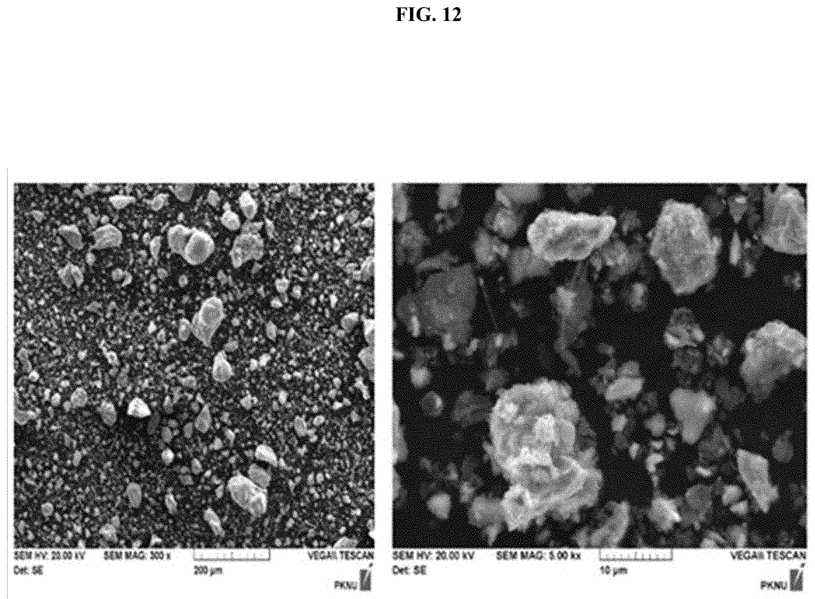

FIG. 11 is a graph of XRD analysis of the powder sample. The graph shows MnO peaks. Further, FIG. 12 shows the SEM image. The powder particles as observed based on the image of the SEM are identified as MnO.

Therefore, it may be identified based on the FIG. 11 and FIG. 12 that Mn is separated from Li via the process according to the present disclosure.

Although the embodiments of the present disclosure have been described in more detail with reference to the accompanying drawings, the present disclosure is not necessarily limited to these embodiments. The present disclosure may be implemented in various modified manners within the scope not departing from the technical idea of the present disclosure. Accordingly, the embodiments disclosed in the present disclosure are not intended to limit the technical idea of the present disclosure, but to describe the present disclosure. the scope of the technical idea of the present disclosure is not limited by the embodiments. Therefore, it should be understood that the embodiments as described above are illustrative and non-limiting in all respects. The scope of protection of the present disclosure should be interpreted by the claims, and all technical ideas within the scope of the present disclosure should be interpreted as being included in the scope of the present disclosure.

What is claimed is:

1. A method for recovering lithium oxide (Li₂O) from lithium manganese oxide (LMO), the method comprising producing lithium oxide via thermal reaction of lithium manganese oxide (LMO) in a hydrogen atmosphere.

2. The method of claim 1, wherein the method further comprises performing water leaching of the produced lithium oxide to separate the lithium oxide from other products.

3. The method of claim 1, wherein a temperature of the thermal reaction is equal to or higher than 800° C.

4. The method of claim 1, wherein a temperature of the thermal reaction is equal to or higher than 1000° C.

5. The method of claim 2, wherein the water leaching includes separating the lithium oxide from the other products based on a difference between solubility of the lithium oxide and solubility of the other products.
